(19) United States
(12) Patent Application Publication
(10) Pub. No.: US 2008/0230605 A1
(43) Pub. Date: Sep. 25, 2008

(54) PROCESS AND APPARATUS FOR MAINTAINING DATA INTEGRITY

(76) Inventors: Brian Weichel, West Lafayette, IN (US); Rick Gardner, Victoria (AU)

Correspondence Address: BOSE MCKINNEY & EVANS LLP;2700 FIRST INDIANA PLAZA, 135 NORTH PENNSYLVANIA, INDIANAPOLIS, IN, 46204, US

(21) Appl. No.: 11/948,267

(22) Filed: Nov. 30, 2007

Related U.S. Application Data
(60) Provisional application No. 60/867,884, filed on Nov. 30, 2006.

(51) Int. Cl. G06F 19/00

(52) U.S. Cl. 235/385

(57) ABSTRACT

A process for maintaining data integrity of a sample. The process includes scanning a substrate barcode, scanning a sample barcode, placing the sample into a rack at a position that is identified, depositing the sample onto the substrate at a trackable well location, re-scanning the substrate barcode, analyzing the substrate to collect data representative of the deposited sample, and displaying the representative data. The substrate barcode and the sample barcode can be configured to relay information to a software program, which is also configured to identify and store information related to the trackable well location where the sample is placed on the substrate. The substrate barcode can also be configured to indicate a characteristic of the deposited sample and relay it to the software program.

### CROSS-REFERENCE TO RELATED APPLICATIONS

This application claims the benefit of U.S. Provisional Patent Application, Ser. No. 60/867,884, filed Nov. 30, 2006, titled Process and Apparatus for Maintaining Data Integrity, the disclosure of which is expressly incorporated herein by reference. This application is related to U.S. patent application Ser. No. 10/726,772, entitled “Adaptive Interferometric Multi-Analyte High-Speed Biosensor,” filed Dec. 3, 2003 (published on Aug. 26, 2004 as U.S. Pat. Pub. No. 2004/0166593), which is a continuation-in-part of U.S. Pat. No. 6,685,885, filed Dec. 17, 2001 and issued Feb. 3, 2004, the disclosures of which are all incorporated herein by this reference. This application is also related to U.S. patent application Ser. No. 11/345,462 entitled “Method and Apparatus for Phase Contrast Quadrature Interferometric Detection of an Immunoassay,” filed Feb. 1, 2006; and also U.S. patent application Ser. No. 11/345,477 entitled “Multiplexed Biological Analyzer Planar Array Apparatus and Methods,” filed Feb. 1, 2006; and also U.S. patent application Ser. No. 11/345,564, entitled “Laser Scanning Interferometric Surface Metrology,” filed Feb. 1, 2006; and also U.S. patent application Ser. No. 11/345,566, entitled “Differentially Encoded Biological Analyzer Planar Array Apparatus and Methods,” filed Feb. 1, 2006, the disclosures of which are all incorporated herein by this reference.

### TECHNICAL FIELD

The present invention generally relates to a process and apparatus for maintaining the integrity of data, and particularly to a process and apparatus for preserving the integrity of data generated by processing biological samples disposed on a substrate.

### BACKGROUND

In many chemical, biological, medical, and diagnostic applications, it is desirable to detect the presence of specific molecular structures in a sample. Many molecular structures such as cells, viruses, bacteria, toxins, peptides, DNA fragments, and antibodies are recognized by particular receptors. Biochemical technologies including gene chips, immunological chips, and DNA arrays for detecting gene expression patterns in cancer cells, exploit the interaction between these molecular structures and the receptors. [For examples see the descriptions in the following articles: Sanders, G. H. W. and A. Manz, Chip-based Microsystems for genomic and proteomic analysis. Trends in Anal. Chem., 2000, Vol. 19(6), p. 364-378. Wang, J., From DNA biosensors to gene chips. Nucl. Acids Res., 2000, Vol. 28(16), p. 3011-3016; Hagman, M., Doing immunology on a chip. Science, 2000, Vol. 290, p. 82-83; Marx, J., DNA Arrays reveal cancer in its many forms. Science, 2000, Vol. 289, p. 1670-1672]. These technologies generally employ a stationary chip prepared to include the desired receptors (those that interact with the target analyte or molecular structure under test). Since the receptor areas can be quite small, chips may be produced which test for a plurality of analytes. Ideally, many thousand binding receptors are used to provide a complete assay. When the receptors are exposed to a biological sample, only a few may bind a specific protein or pathogen. Ideally, these receptor sites are identified in as short a time as possible.

One such technology for screening for a plurality of molecular structures is the so-called immunological compact disc, which simply includes an antibody microarray. [For examples, see the descriptions in the following articles: Ekins, R., F. Chu, and E. Biggart, Development of microspot multi-analyte ratiometric immunoassay using dual flourescent-labelled antibodies. Anal. Chim. Acta, 1989, Vol. 227, p. 73-96; Ekins, R. and F. W. Chu, Multianalyte microspot immunoassay—Microanalytical “compact Disk” of the future. Clin. Chem., 1991, Vol. 37(11), p. 1955-1967; Ekins, R., Ligand assays: from electrophoresis to miniaturized microarrays. Clin. Chem., 1998, Vol. 44(9), p. 2015-2030]. Conventional fluorescence detection is employed to sense the presence in the microarray of the molecular structures under test. Other approaches to immunological assays employ traditional Mach-Zender interferometers that include waveguides and grating couplers. [For examples, see the descriptions in the following articles: Gao, H., et al., Immunosensing with photo-immobilized immunoreagents on planar optical wave guides. Biosensors and Bioelectronics, 1995, Vol. 10, p. 317-328; Maisenholder, B., et al., A GaAs/AlGaAs-based refractometer platform for integrated optical sensing applications. Sensors and Actuators B, 1997, Vol. 38-39, p. 324-329; Kunz, R. E., Miniature integrated optical modules for chemical and biochemical sensing. Sensors and Actuators B, 1997, Vol. 38-39, p. 13-28; Dübendorfer, J. and R. E. Kunz, Reference pads for miniature integrated optical sensors. Sensors and Actuators B, 1997 Vol. 38-39, p. 116-121; Brecht, A. and G. Gauglitz, recent developments in optical transducers for chemical or biochemical applications. Sensors and Actuators B, 1997, Vol. 38-39, p. 1-7]. Interferometric optical biosensors have the intrinsic advantage of interferometric sensitivity, but are often characterized by large surface areas per element, long interaction lengths, or complicated resonance structures. They also can be susceptible to phase drift from thermal and mechanical effects.

The biological compact disc was introduced as a sensitive spinning-disk interferometer that operates at high-speed and is self-referencing [see M. M. Varma, H. D. Inerowicz, F. E. Regnier, and D. D. Nolte, “High-speed label-free detection by spinning-disk micro-interferometry,” Biosensors & Bioelectronics, vol. 19, pp. 1371-1376, 2004]. These types of optical biosensors are capable of generating images of some optical parameter like fluorescence or reflectance. Generally, various test spots on such biosensors are laid out in periodic patterns or arrays. The Quadraspec BioCD™ system described in the above-referenced U.S. Pat. No. 6,685,885 is a similar array biosensor. The BioCD™ system offers a platform that enables a user to detect (without the need for expensive secondary reagents) up to 1,000 unique antigens, biomarkers or other molecular species on a single array. Further, the platform enables a user to measure concentration levels of complex molecules. Moreover, each biological compact disc has the ability to test for about 256 diseases in roughly 250 patients, thereby resulting in more than 64,000 tests on each disc. Due to the large throughput characteristics of these platforms, it is important to maintain a high level of data integrity, as well as ultra-low variability during the processing stages of these discs. The purpose of this invention is intended to address and overcome one or more of shortcomings of the prior art discussed above.

### SUMMARY OF THE INVENTION

Generally, the Quadraspec BioCD™ system includes software that allows a user to use a barcode scanner to load up samples, sample racks, as well as discs. The barcodes of the samples are tracked as they are assigned to a specific well on the disc. After scanning a disc, algorithms are run on the data and the results of each assay are displayed for the user. Thereafter, each sample is correlated with the assay that was run on the disc.

In one exemplary embodiment of the present invention, a process for maintaining data integrity of a sample deposited on a substrate having a plurality of well locations is provided. The process comprises scanning a substrate barcode, scanning a sample barcode, placing the sample into a rack at a position that is identified and trackable, depositing the sample onto the substrate at a trackable well location, re-scanning the substrate barcode, analyzing the substrate to collect data representative of the deposited sample, and displaying the representative data. The substrate barcode and the sample barcode can be each configured to relay information to the software program, which is also configured to identify and store information related to the trackable well location where the sample is placed on the substrate. The substrate barcode is also configured to indicate a characteristic of the deposited sample and relay it to the software program.

In another exemplary embodiment in accordance with the present invention, an apparatus for establishing a reference point on a substrate adapted to receive a biological sample is provided. The apparatus comprises a platform to support the substrate, and first, second, and third pins disposed about the platform. The first pin is located at an arcuate edge of the substrate, and the second and third pins are located at a flat of the substrate.

There is also provided a support for a substrate adapted to receive a biological sample. The support includes a platform having an outer portion and a support surface to support the substrate. The platform includes a plurality of holes with each of the holes being disposed at the support surface and each being coupled to the outer surface through a channel. A plurality of pins can be coupled to the platform, to locate the substrate on the support.

### BRIEF DESCRIPTION OF THE DRAWINGS

The detailed description of the drawings particularly refers to the accompanying figures in which:

FIG. 1 is a screen display of a user interface screen used to begin a sample preparation to identify a disc or disc package by scanning a barcode.

FIG. 2 is a screen display of a user interface screen used to continue a sample preparation to identify samples contained in a sample rack by scanning a barcode.

FIG. 3 is a perspective view of a sample processor.

FIG. 4 is a partial perspective view of stage/mounting device.

FIG. 5 is a screen display of a user interface screen to scan a barcode on a disc.

FIG. 6 is a partial perspective view of a disc located on a mount of a sample reader.

FIG. 7 is a screen display of a user interface screen of the results of reading samples from a disc located on a mount of a sample reader.

FIG. 8 is a perspective view of a disc located on a disc chuck of a stage/mounting device.

FIG. 9 is a perspective view of a disc chuck.

FIG. 10 is a cross section along a line 10-10 of FIG. 9 illustrating a tunnel or channel of the disk chuck.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

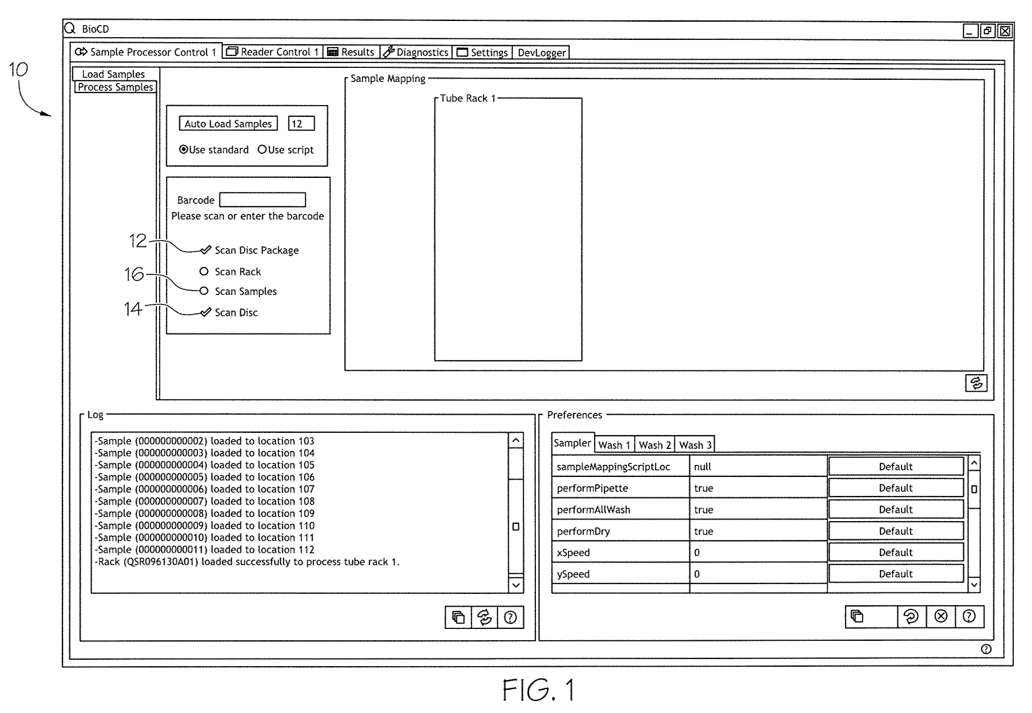

According to one exemplary embodiment of the present invention, a user starts with the software running and a barcode scanner. (see FIG. 1 which illustrates a sample screen shot 10 of the exemplary software embodiment discussed herein). The user first scans a barcode that is associated with the disc by selecting a scan disc package selector 12 or a scan disc selector 14. The barcode can be located on either the disc itself or on the package in which the disc is contained.

Barcodes are generally known within the art and therefore are not discussed in detail herein. Moreover, those of skill in the art will understand and appreciate that the disc barcodes can be programmed with specific information to be relayed to the software, such as what tests will be run on the disc and/or what is its physical storage capacity. After the disc is scanned, the user mounts the disc to the sample processor. Alternatively and/or in addition to scanning the disc itself, the user could also scan the disc package, which would also be configured to tell the software what kind of tests to run, etc. By scanning the disc package, the user could begin loading samples while the sample processor is in use.

Next, the user will scan a barcode on the sample rack that holds the various samples to be analyzed by selecting the scan samples selector 16. The samples can also individually scanned as they are placed into the rack. This process is continued until there are no more samples and/or if the capacity of the disc is filled. At this point, if the user has not yet scanned the disc, the disc will be scanned by the barcode reader.

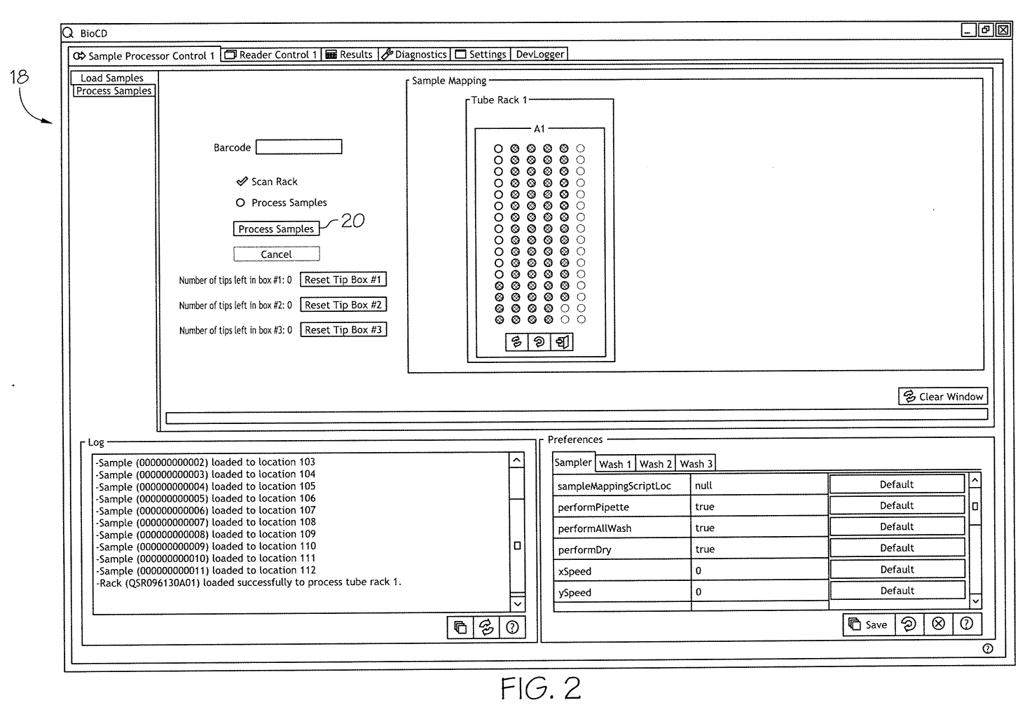

After the barcodes are scanned as indicated above, the user will be instructed by the software to begin processing the samples. An exemplary screenshot 18 depicting this step is illustrated in FIG. 2. The user will scan a barcode on the sample rack, load it into the sample processor and click a “process samples” button or selector 20. After the samples are processed, the disc is scanned once more and loaded into a reader, where the disc will be analyzed. Finally, the results are displayed for the user.

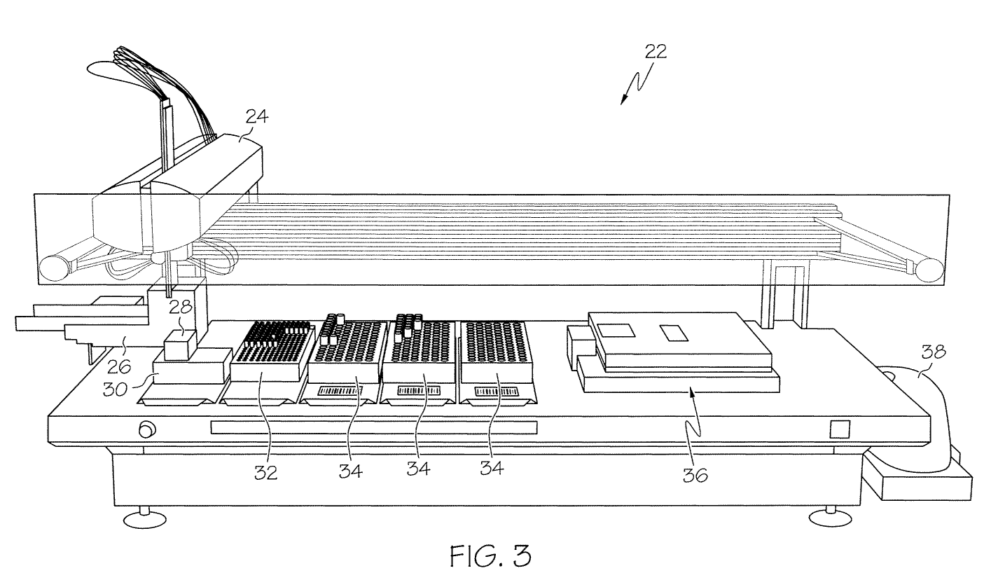

An exemplary sample processor 22 in accordance with the present invention is shown with reference to FIG. 3 below. This exemplary processor automates assay protocols and offers extraordinary throughput characteristics. For instance, for assays requiring a 30-minute incubation time, the sample processor 22 is capable of running 250 samples per hour. Further, it is also possible to have up to three sample processors managed by a single workstation and reader. This flexibility allows for modular expansion opportunities, particularly if a laboratory's throughput needs change.

The sample processor shown here in this exemplary illustration for Quadraspec's BioCD™ system is an Inspira™ sample processor, which is based on a Xantus platform (manufactured by Sias AG—Hombrechtikon, Switzerland). More detailed information about the Xantus sample platform that is described in this exemplary embodiment can be found in the brochure entitled, “Xantus Modular, Flexible, Upgradeable Robotic Solution,” which is incorporated by reference herein in its entirety. It should be appreciated and understood that other such sample processing platforms could also be used in conjunction with the present invention without straying from the scope or spirit of the present teachings. For simplicity purposes, however, the present description focuses on Quadraspec's Inspira™ sample processor.

Quadraspec's Inspira™ sample processor 22 (shown in FIG. 3) includes a robotic arm 24, a tip strip station 26, a flush and trough station 28, a control station 30, disposable tips 32, tube racks 34, a disc station 36, a system fluid bottle 38, and a waste bottle (not pictured). When the user loads the software, the software boots and verifies the configuration files used to identify what hardware exists in the system. Exemplary hardware that may be used in accordance with the present invention includes, but is not limited to, reader(s), sampler(s), as well as any subcomponents and accessories of each. The user next scans a disc barcode, either manually with a hand held bar code reader or the included bar code reader, and loads the disc into the sample processor. The software identifies the type of disc that is to be analyzed, what tests are to be run on the disc, as well as how many wells it has and what processing steps need to be performed. There are many different disc configurations usable with the present invention. As mentioned above, one exemplary disc platform is the Quadraspec BioCD™ system, which includes various disc formats (e.g., the 84-well heartworm disc, the 108-well disc and the 260-well disc). It should be understood and appreciated that each disc will have different parameters based on the tests that are being run, e.g., incubation times, well assignments, wash buffers, and the general procedure being performed. These parameters will all be incorporated into the barcode and thereby recognized by the software when scanned by the barcode reader.

After the disc is scanned by the barcode reader, the software assigns a unique identifier to the disc so that it can be individually tracked throughout the process. More particularly, during processing, information on a given disc (and its samples disposed thereon) is stored by the software program as an ‘object instance,’ which is unique to the system and assigned a numerical location in the system's memory. To maintain the integrity of the process, the assigned identifier is different for each scanned disc and cannot be reassigned after it has been initially used.

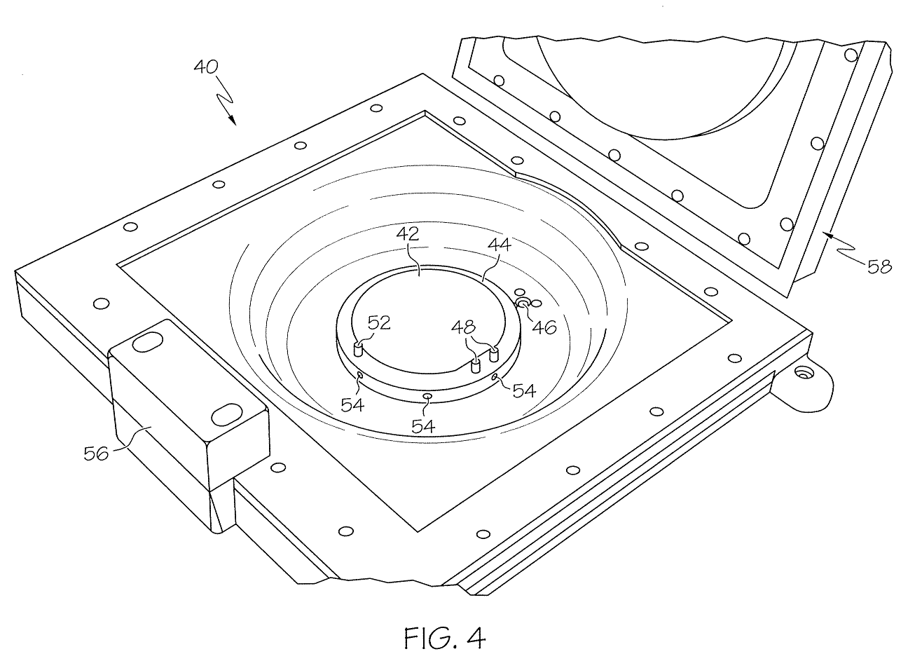

To hold the disc into place as it is processed by the sample processor, a stage/mounting device 40 is used. The stage/mounting device 40 is depicted in FIG. 4 and includes a BioCD™ disc 42 which can be made of silicon mounted on a disc chuck 44, a drain 46, alignment pins 48 for a flat 50 of the disc 42, an alignment pin 52 for the side of the disc other than the flat, Venturi holes 54 (lead to below disc, used to suction disc to chuck), a lid latch 56, and a lid 58. The disc can also be held into place within the sample processor by a magnet (not shown in the illustration of FIG. 4). The device is designed in such a manner that a specific and known location on the disc can easily be referenced at any time throughout the process. More particularly, due to the inherent difficulty of referencing a center position of a disc (or similar silicon wafer) whose dimensions have high variability (diameter, length of flat, etc.), the present inventors have developed a way to reference a point on the disc without having to center the disc. Using 3-pins, an artificial center point can be assigned to the disc, which will be constant across all phases of use (barrier/pad printing of the disc, antibody printing of the disc, sample application and interferometric disc reading). More particularly, all stages in the disc manufacturing key off of the same 3-pin locations in every chuck used, so any x,y location can be identified based on any x,y offset from these pins. Since the center point is an x, y offset, the locations on the disc can be converted to r, theta.

Moreover, the design of the stage/mounting device is configured such that the center of mass of the disc is located on the side of the center of rotation closest to the pins, thereby allowing the centrifugal force to help improve the alignment, and at the same time, prevent the disc from flying off the platform. This design works in conjunction with the Venturi holes 54 shown in FIG. 4. While the Venturi design can be utilized in any of the disclosed processing stages, it is particularly helpful when sampling the disc with the sample processor, as well as reading the disc with the reader. The holes work by creating a tunnel or channel between the outer edge and the underside of the disc. When the chuck spins, there is a low-pressure zone created by the fast moving air. The tunnel therefore has a lower pressure than the rest of the surface of the chuck (pressure increases to ambient as you decrease the surface radius towards the stationary center, as far as air movement is concerned). As such, the holes on the surface of the chuck (which are normally located underneath the disc) create a suctioning effect that assists in holding the disc to the platform. When the chuck stops spinning, there is no more suction, and the disc can be removed. More details regarding the 3-pin mounting device are provided below.

The Quadraspec BioCD™ system utilizes a disc as the carrier of diagnostic assays (the test pattern). The disc, and hence test pattern, passes through three processing stages before a diagnostic result is attained. This can result in a tolerance stack-up over these multiple stages “over time,” as distinct from the usual tolerance stack up within a single instrument or device. The three processing stages include: 1) disc printing—which includes two steps (i.e., a ‘pad print’ to do the well boundaries of the disc and a ‘protein print,’ which prints the array of antibody spots on the disc; 2) sample processing; and 3) disc reading. The 3-pin mounting device is designed to minimize tolerance build-up and errors as the discs go through each of the three processing stages.

Various definitions used to describe the 3-pin mounting device herein are as follows: Chuck—The holder of the disc; Disc—The carrier of the diagnostic assays test pattern; Test Pattern—Arrangement of wells on the disc; and Well—Area on the disc for holding diagnostic assays and conducting tests. It should also be understood herein that each printed spot on the disc can be an assay, or a collection of spots.

During the disc printing step, the disc is placed on the chuck and the well pattern is printed onto the disc. The printing will include the following features: the antibodies will be added to each well, the hydrophobic barrier is added to the area around each well, and a rotational marker is added for the reader. Additionally, a ‘key’ is included in the pad print design, which can be used to determine orientation of the disc. Once the disc is moved to the sample processing step, the printed disc will be placed on a chuck in the sample processor (shown in FIG. 3). A pipettor will dispense samples, standards and quenching buffer into pre-determined wells in the disc. The pipettor has to align with the printed wells on the disc. Finally, when the disc is advanced to the disc reading step, the processed disc will be placed on a chuck in the reader, and the reader will measure the wells for reactions between the sample and the antibodies. The reader has to be able to determine the locations of the pre-determined wells in order to correlate the measurements with the sample number.

An exemplary illustration of various disc dimensions and tolerances useful in accordance with the present invention is shown below.

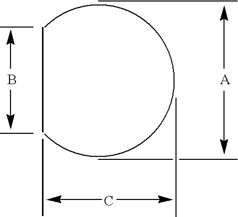

| Dimension | Description | Value and tolerance |
|---|---|---|
| A | Diameter of disc | 100 mm ± 0.5 |
| B | Length of Flat | 32.5 mm ± 2.5 |
| C | Across Flat (calculated) | 96.32 min, 98.21 |
| | | max |
| — | Thickness (silicon) | 0.545 mm ± 0.02 |
| — | Thickness (glass) | 1.1 mm ± 0.1 |

An exemplary illustration of various chuck dimensions and tolerances useful in accordance with the present invention is shown below. As explained above, the chuck will have three pins to locate the disc (shown by the “circles” in the illustration below).

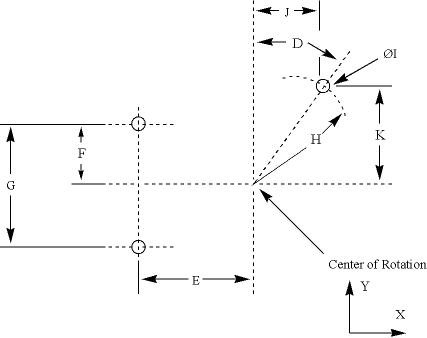

| Dimension | Description | Value and tolerance |
|---|---|---|
| D | Angular position of single pin | 12°34′ [symbol] |
| E | ‘X’ position of pair of pins | 50.786 mm [symbol] |
| F | ‘Y’ Position of pair of pins | 8.125 mm [symbol] |
| G | Pitch of pair of pins | 16.25 mm [symbol] |
| H | Radial position of single pin | 52.7 mm [symbol] |
| I | Diameter of each pin | 5.004, 5.012 mm |
| J | ‘X’ position of single pin | 11.466 mm |
| K | ‘Y’ position of single pin | 51.437 mm |

Exemplary pattern dimensions and tolerances useful in accordance with the present invention are shown below.

| | | |
|---|---|---|
| Outer diameter of hydrophobic wall | 90.0 | mm |
| Tolerance on the outer diameter of the | ±0.5 | mm |
| hydrophobic wall | | |
| Inner Diameter of hydrophobic wall | 7.2 | mm |
| Tolerance on the inner diameter of the printing | ±0.05 | mm |
| Tolerance on the placement of the printed | | |
| pattern relative to the centre of rotation | | |

Continuing with the description of the exemplary process, next the user scans a barcode on the sample rack. The software will identify the type of rack that is being used, as well as tubes (or microtiters) it holds and its physical size. One exemplary sample rack that may be used with the present invention includes a 96-well 13 mm tube rack (see reference numeral 34 in FIG. 3). It should be understood and appreciated that other sizes of sample racks may also be used without straying from the scope of the present invention. In addition, it should be appreciated that microtiter plates can alternatively be used as sample racks. As such, the present invention is not intended to be limited herein.

Next, the user scans and loads samples into the rack. Each sample is associated with a rack position so that it can be tracked throughout the processing steps. After the sample rack is loaded with samples, the user loads the rack onto the sample processor and scans the rack barcodes to confirm their location (see FIG. 2). The location of each rack is now known, as well as the positioning of each sample tube/titer.

The user proceeds with starting the sample processor. When the sample processing starts, samples are picked up and transferred to the disc. More particularly, the arm 28 of FIG. 3 moves in the x direction as illustrated, and the tips all move individually in both the y and z directions as illustrated. Samples may be aspirated in groups of eight, and dispensed in pairs in opposite quadrants by rotating the disc and adjusting the x and y locations. Since the disc pattern is round and symmetrical, a stage or chuck 44 rotates to provide access to the appropriate area of the disc and two samples are dispensed simultaneously in opposite quadrants. This involves a rotational (theta) and positional (y, and x if desired) offset. The position that each sample is placed on the disc is then stored in a single ‘object’ in the software, which relates the sample identifier barcode, rack location, and well location on the disc together. After pipetting and incubating in a humidity-controlled environment, the disc is treated, washed and dried automatically. Those of skill in the art will appreciate that the treating of the disc will depend on the assay used. For instance, some assays may get an additional dispense of buffer, blocker, fluorescence label and/or reagent. Wash fluids are dispensed from a bulk fluid nozzle attached to the tip (see reference numeral 38 in FIG. 3).

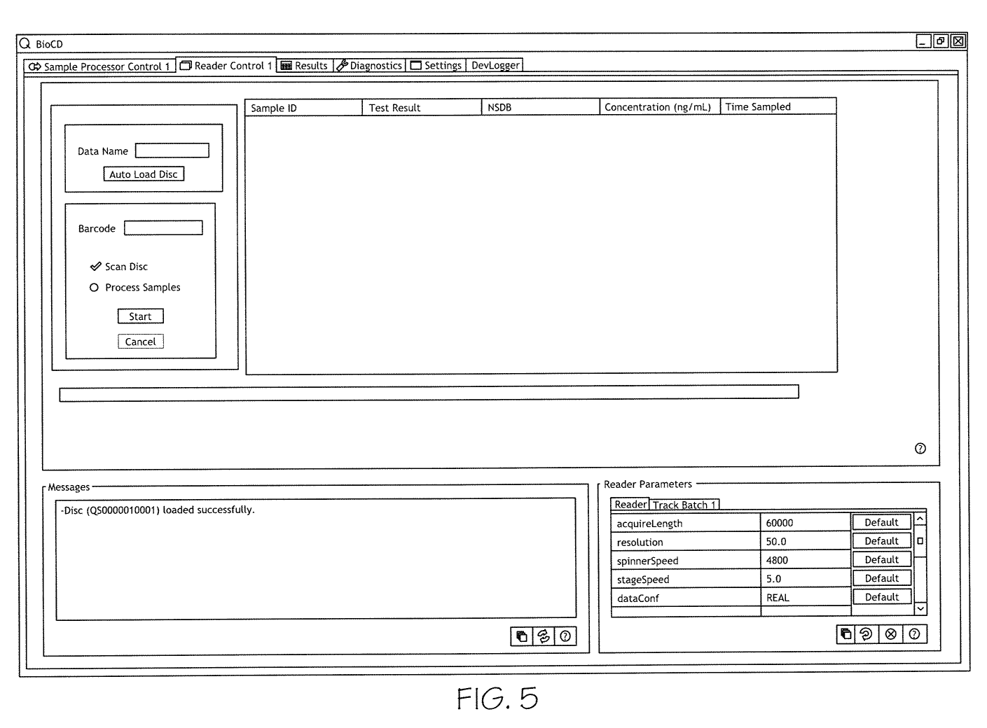

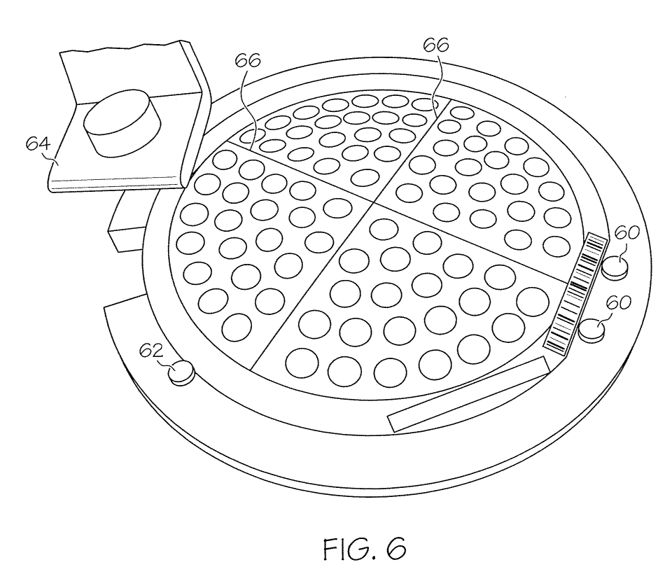

Next, the user removes the disc from the sample processor and puts it into a reader, a portion of which is shown in FIG. 6. At this step, the user once again scans the barcode (see FIG. 5). The mount in the reader utilizes the same 3-pin design described in detail above to provide precisely known locations on the disc. FIG. 6 shows the 3-pins of the reader chuck. The reader includes alignment pins 60 for the flat of the disc and an alignment pin 62 for the side of the disc other than the flat, which in this case is an arcuate edge. Once the barcode is scanned, the software knows exactly what disc (and what samples) are going to be read. The pertinent information for each sample is then stored in the software as a ‘Sample’ object. A ‘Disc’ object also exists to store information on that disc, including the Sample objects themselves associated with a specific well number on that disc. When a disc is scanned in, the Disc object is retrieved along with the corresponding Sample objects.

The user next begins the reading process. Here, a reader 64 collects data (normally in concentric tracks) from the disc and stores it for analysis. A light source of the reader 64 creates lines 66. To minimize the data collection time, a multi-threaded pipeline approach can be used. As is known in the software engineering art, a thread is an instance of code that runs on its own so that multiple things can be done at one time. A pipeline is a process that is done one stage at a time (data moves from one stage to the next as if in a pipe). As applied to the present application, the reader collects data at a very high speed by prioritizing the threads, which operate each stage of the pipeline. The initial read is highest in priority and the data processing steps then happen in a specific order. If the pipeline steps later fall behind, eventually the queue will fill-up and the read will be forced to wait for a while. It is also noted that when running a multi-threaded pipeline in accordance with the present invention, multiple CPUs are associated with the computer running the system.

After the disc is read, it is removed from the reader and can optionally be discarded. The collected data is then analyzed and the results posted. Each sample is correlated to the correct position on the disc. More particularly, various algorithms are used to generate an image, and with that image, the wells are identified. These wells are in a known location since the trigger mechanism in the reader starts each track acquisition from a line bisecting the flat of the disc. By counting the pixels, various spots on the disc can be determined and therefore what well number is being analyzed. In addition, the ‘Disc’ object correlates well numbers with the sample ‘ID's’. During this process, the user has the option of using the reader and the sample processor for new discs, while all of the data integrity is preserved. The results are then stored either locally or through an associated program that is accessible by the user.

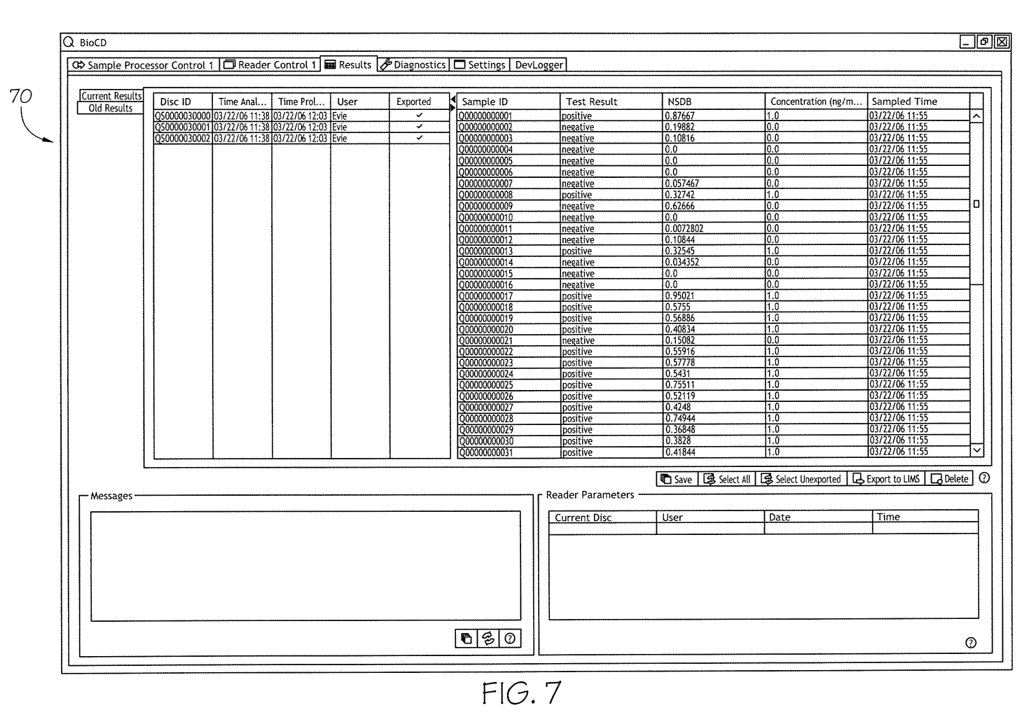

Finally, the user views and exports the results at a user interface screen 70 (see FIG. 7) for further review and analysis as needed. The results are then displayed for the user so that the various concentrations of the samples can be determined, etc. The results can also be streamed to a Laboratory Information System for transfer to a customer if desired.

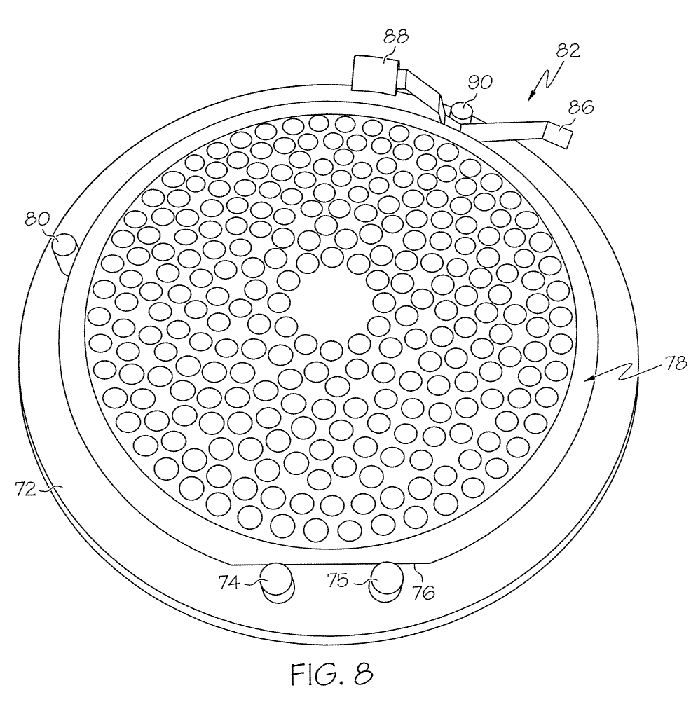

FIG. 8 illustrates one embodiment of a chuck 72. The chuck 72 can be used in either the stage/mounting device 40 of FIG. 4 or the reader of FIG. 6. The chuck 72 includes a first alignment pin 75 and a second alignment pin 75 which contact a flat 76 or straight edge of a disc 78 as previously described. An alignment pin 80 contacts a portion of the disc other than the flat 76. In the case of a substantially circular disc, the alignment pin 78 contacts the curved outer circumferential portion or edge of the disc. A holder 82 holds the disc at a substantially fixed position by contacting a portion 84 of an outer edge of the disc 78.

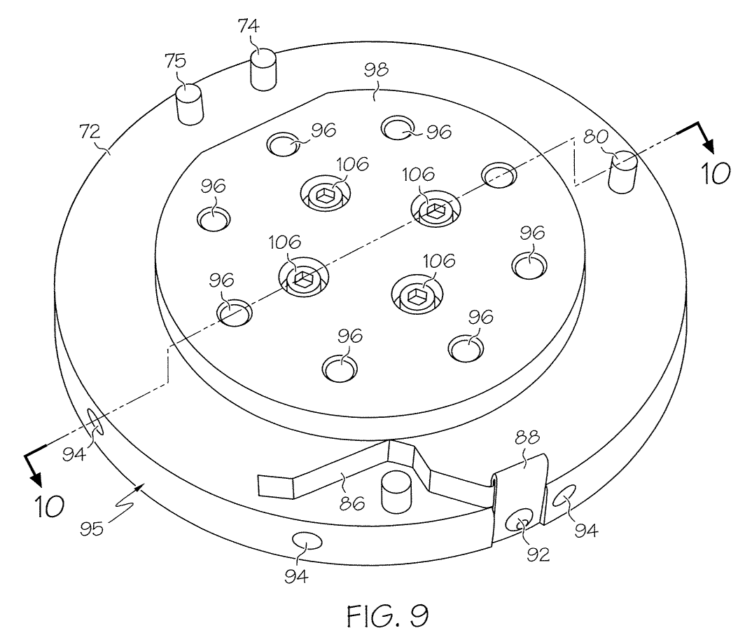

The holder 82 includes a spring 86 coupled to a clip 88. The clip holds one end of the spring 86 at a fixed position. The opposite end of the spring 86 can move freely within a certain range of motion defined the outside edge of the disc 78 and a stop 90. As further illustrated in FIG. 9, a fastening device 92, such as a screw, holds the clip 88 to the chuck 72 (shown without the disc 78). One end of the spring 86 is held by the clip 92.

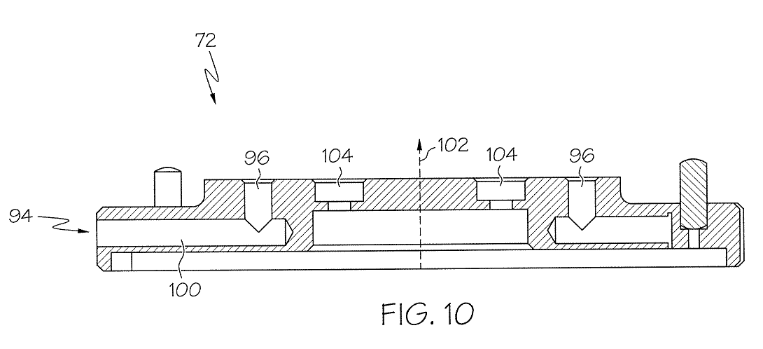

The chuck 72 includes a plurality of apertures 94 which are located at an outer portion or surface 95 of the chuck 72. The apertures 94 connect to a second plurality of apertures 96 located on an upper surface 98. As further illustrated in FIG. 10, each of the apertures 94 is coupled to one of the apertures 96 though a tunnel or channel 100. When the chuck spins about a rotational axis, a Venturi effect is created by the apertures 94 which in combination with the channels 100 provide a suction force through the apertures 96 to the underside of a disc. In addition to the suction force, the disc is held in place against the pins 74 due to the rotational force of the chuck since the pins locate the center of the disc slightly off-center of a rotational axis 102. Consequently, it is possible to consistently prepare a disc and to read results from a disc even though the disc moves from the stage/mounting device 40 to the reader. The chuck 72 additionally includes a plurality of mounting holes 104 which receive fasteners 106 to hold the chuck to the motor which spins the chuck.

If the system is used in a lab setting for developing assays (or other such research purposes), the user can also have the option of ‘scripting’ the processes that are being implemented. For instance, they can pipette between different racks, mix solutions, customize wash and dry protocols, all with minimal effort. These features can also be locked out of the product if desired.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCES

The following references are incorporated herein by reference in their entirety:
1. Sanders, G. H. W. and A. Manz, Chip-based Microsystems for genomic and proteomic analysis. Trends in Anal. Chem., 2000, Vol. 19(6), p. 364-378
2. Wang, J., From DNA biosensors to gene chips. Nucl. Acids Res., 2000, Vol. 28(16), p. 3011-3016
3. Hagman, M., Doing immunology on a chip. Science, 2000, Vol. 290, p. 82-83
4. Marx, J., DNA Arrays reveal cancer in its many forms. Science, 2000, Vol. 289, p. 1670-1672
5. Ekins, R., F. Chu, and E. Biggart, Development of microspot multi-analyte ratiometric immunoassay using dual flourescent-labelled antibodies. Anal. Chim. Acta, 1989, Vol. 227, p. 73-96
6. Ekins, R. and F. W. Chu, Multianalyte microspot immunoassay—Microanalytical “compact Disk” of the future. Clin. Chem., 1991, Vol. 37(11), p. 1955-1967
7. Ekins, R., Ligand assays: from electrophoresis to miniaturized microarrays. Clin. Chem., 1998, Vol. 44(9), p. 2015-2030
8. Gao, H., et al., Immunosensing with photo-immobilized immunoreagents on planar optical wave guides. Biosensors and Bioelectronics, 1995, Vol. 10, p. 317 328
9. Maisenholder, B., et al., A GaAs/AlGaAs-based refractometer platform for integrated optical sensing applications. Sensors and Actuators B, 1997, Vol. 38-39, p. 324-329
10. Kunz, R. E., Miniature integrated optical modules for chemical and biochemical sensing. Sensors and Actuators B, 1997, Vol. 38-39, p. 13-28
11. Dübendorfer, J. and R. E. Kunz, Reference pads for miniature integrated optical sensors. Sensors and Actuators B, 1997 Vol. 38-39, p. 116-121
12. Brecht, A. and G. Gauglitz, recent developments in optical transducers for chemical or biochemical applications. Sensors and Actuators B, 1997, Vol. 38-39, p. 1-7
13. M. M. Varma, H. D. Inerowicz, F. E. Regnier, and D. D. Nolte, “High-speed label-free detection by spinning-disk micro-interferometry,” Biosensors & Bioelectronics, vol. 19, pp. 1371-1376, 2004

1. A process for maintaining data integrity of a sample deposited on a substrate having a plurality of well locations, comprising:
scanning a substrate barcode, the substrate barcode being associated with the substrate and including information representative of the substrate;
scanning a sample barcode, the sample barcode including information representative of the sample;
placing the sample into a rack at a position that is identified and trackable;
depositing the sample onto the substrate at a trackable well location, the trackable well location being identifiable;
re-scanning the substrate barcode, the substrate barcode indicating a characteristic of the deposited sample contained thereon;
analyzing the substrate including the deposited sample to collect data representative of the deposited sample; and
displaying the representative data.

2. The process of claim 1, wherein scanning the substrate barcode comprises scanning the substrate barcode with a barcode reader.

3. The process of claim 1, wherein scanning the sample barcode comprises scanning the sample barcode with a barcode reader.

4. The process of claim 1, further comprising scanning a rack barcode with a barcode reader, the rack barcode including information representative of the rack.

5. The process of claim 1, wherein the substrate comprises a biological compact disc.

6. The process of claim 1, wherein analyzing the substrate comprises analyzing the substrate with a reader apparatus.

7. The process of claim 1, wherein data representative of the deposited sample comprises a concentration of the deposited sample.

8. The process of claim 1, wherein the sample comprises a biological sample.

9. The process of claim 1, further comprising assigning a unique identifier to the substrate, the unique identifier being recognizable.

10. An apparatus for establishing a reference point on a substrate adapted to receive a biological sample, comprising:
a platform to support the substrate; and
a first and a second pin disposed about the platform to contact a flat of the substrate.

11. The apparatus of claim 10, further comprising a third pin, the third pin being disposed about the platform to contact an edge of the substrate other than the flat.

12. The apparatus of claim 11, wherein the edge of the substrate other than the flat includes an arcuate edge.

13. The apparatus of claim 12, wherein the substrate is a biological compact disc.

14. The apparatus of claim 10, wherein the platform includes at least one hole to provide a suction to the substrate.

15. A support for a substrate adapted to receive a biological sample, the support comprising:
a platform including an outer portion and a support surface to support the substrate, the platform including a plurality of holes, each of the holes being disposed at the support surface and each being coupled to the outer surface through a channel; and
a plurality of pins, coupled to the platform, to locate the substrate on the support.

16. The support of claim 15, wherein the support includes a motor, coupled to the, platform, to rotate the platform.

17. The support of claim 15, wherein the support surface is substantially planar with each of the plurality of holes being located along a curve.

18. The support of claim 17, wherein the outer portion includes a surface substantially perpendicular to the support surface, wherein each of the channels defines an aperture located at the outer portion.

19. The support of claim 17, wherein the platform includes a center of rotation and the plurality of pins locates a center of the substrate on the platform, the center of rotation being different than the located center of the substrate.

20. The support of claim 19, further comprising a spring, coupled to the platform, to contact an edge of the substrate and to bias the substrate toward the plurality of pins.
